(19) United States
(12) Patent Application Publication
(10) Pub. No.: US 2026/0323500 A1
(43) Pub. Date: Oct. 15, 2026

(54) APPARATUS AND METHOD FOR SELECTING PUBLIC LAND MOBILE NETWORK IN WIRELESS COMMUNICATION SYSTEM

(71) Applicant: LG Electronics Inc., Seoul (KR)

(72) Inventor: Sunhee KIM, Seoul (KR)

(21) Appl. No.: 19/484,577

(22) PCT Filed: Mar. 18, 2024
(86) PCT No.: PCT/KR2024/095581

§ 371 Date: Nov. 14, 2025

Related U.S. Application Data
(60) Provisional application No. 63/466,353, filed on May 15, 2023.

(51) Int. Cl. H04W 48/18; H04W 8/18; H04W 84/04

(52) U.S. Cl. CPC H04W 48/18; H04W 8/183; H04W 84/042

(57) ABSTRACT

The present disclosure is for selecting a public land mobile network (PLMN) in a wireless communication system, and a method performed by a terminal comprises the steps of: determining whether signal level enhanced network selection (SENSE) is applicable; and performing PLMN selection on the basis of whether the SENSE is applicable, and if the SENSE is applicable to the terminal, the PLMN selection may be performed on the basis of a signal threshold value, and if the SENSE is not applicable to the terminal, the PLMN selection may be performed on the basis of priority.

### TECHNICAL FIELD

The following description relates to a wireless communication system, and more particularly, to an apparatus and a method for selecting a public land mobile network (PLMN) in a wireless communication system.

### BACKGROUND ART

Wireless access systems are being widely deployed to provide various types of communication services such as voice and data. Generally, a wireless access system is a multiple access system that can support communication with multiple users by sharing available system resources (bandwidth, transmission power, etc.). Examples of multiple access systems include Code Division Multiple Access (CDMA) systems, Frequency Division Multiple Access (FDMA) systems, Time Division Multiple Access (TDMA) systems, Orthogonal Frequency Division Multiple Access (OFDMA) systems, Single Carrier Frequency Division Multiple Access (SC-FDMA) systems, and the like.

In particular, as many communication devices require large communication capacity, enhanced Mobile Broadband (eMBB) communication technology that is improved compared to existing Radio Access Technology (RAT) has been proposed. In addition, communication systems considering not only massive Machine Type Communications (mMTC) that connects multiple devices and objects to provide various services anytime and anywhere, but also reliability and latency sensitive services/User Equipment (UE) have been proposed. Various technical configurations for this purpose are being proposed.

### DISCLOSURE

### Technical Problem

The present disclosure relates to a device and method for performing signal level-based network selection in a wireless communication system.

The present disclosure relates to a device and method for determining whether a user equipment (UE) can apply signal level enhanced network selection (SENSE) based on an access technology in a wireless communication system.

The present disclosure relates to a device and method for determining whether SENSE is applicable based on whether an access technology related to a signal threshold is supported in a wireless communication system.

The present disclosure relates to a device and method for performing public land mobile network (PLMN) selection based on SENSE applicability in a wireless communication system.

The present disclosure relates to a device and method for determining a PLMN selection method based on SENSE applicability in a wireless communication system.

The technical objectives to be achieved by the present disclosure are not limited to the matters mentioned above, and other technical problems not mentioned may be considered by those skilled in the art to which the technical configuration of the present disclosure is applied from the embodiments of the present disclosure to be described below.

### Technical Solution

In an embodiment of the present disclosure, a method performed by a User Equipment (UE) in a wireless communication system comprises, determining whether a Signal Level Enhanced Network Selection (SENSE) is applicable, and performing a Public Land Mobile Network (PLMN) selection based on whether the SENSE is applicable, wherein, based on the SENSE being applicable to the UE, the PLMN selection is performed based on a signal threshold, wherein, based on the SENSE not being applicable to the UE, the PLMN selection is performed based on a priority, and wherein whether the SENSE is applicable is determined based on whether the UE supports at least one access technology among access technologies related to a signal threshold configured in a Universal Subscriber Identity Module (USIM).

In an embodiment of the present disclosure, a User Equipment (UE) in a wireless communication system comprises a transceiver, and a processor connected to the transceiver, wherein the processor is configured to, determine whether a Signal Level Enhanced Network Selection (SENSE) is applicable, and perform a Public Land Mobile Network (PLMN) selection based on whether the SENSE is applicable, wherein, based on the SENSE being applicable to the UE, the PLMN selection is performed based on a signal threshold, wherein, based on the SENSE not being applicable to the UE, the PLMN selection is performed based on a priority, and wherein whether the SENSE is applicable is determined based on whether the UE supports at least one access technology among access technologies related to a signal threshold configured in a Universal Subscriber Identity Module (USIM).

In an embodiment of the present disclosure, a communication device includes at least one processor, and at least one computer memory connected to the at least one processor and storing instructions that, based on being executed by the at least one processor, perform operations comprising, determining whether a Signal Level Enhanced Network Selection (SENSE) is applicable, and performing a Public Land Mobile Network (PLMN) selection based on whether the SENSE is applicable, wherein, based on the SENSE being applicable to the UE, the PLMN selection is performed based on a signal threshold, wherein, based on the SENSE not being applicable to the UE, the PLMN selection is performed based on a priority, and wherein whether the SENSE is applicable is determined based on whether the UE supports at least one access technology among access technologies related to a signal threshold configured in a Universal Subscriber Identity Module (USIM).

In an embodiment of the present disclosure, a non-transitory computer-readable medium storing at least one instruction comprises the at least one instruction executable by a processor, wherein the at least one instruction cause a device to, determine whether a Signal Level Enhanced Network Selection (SENSE) is applicable, and perform a Public Land Mobile Network (PLMN) selection based on whether the SENSE is applicable, wherein, based on the SENSE being applicable to the UE, the PLMN selection is performed based on a signal threshold, wherein, based on the SENSE not being applicable to the UE, the PLMN selection is performed based on a priority, and wherein whether the SENSE is applicable is determined based on whether the UE supports at least one access technology among access technologies related to a signal threshold configured in a Universal Subscriber Identity Module (USIM).

The above-described aspects of the present disclosure are only some of the preferred embodiments of the present disclosure, and various embodiments reflecting the technical features of the present disclosure can be derived and understood by a person having ordinary skill in the art based on the detailed description of the present disclosure to be described below.

### Advantageous Effects

Embodiments based on the present disclosure may have the following effects.

The present disclosure can determine whether SENSE is applicable based on whether access technology related to signal thresholds is supported in a wireless communication system.

The present disclosure can prevent a user equipment (UE) from performing PLMN selection due to invalid configuration in a universal subscriber identity module (USIM).

The effects obtainable from the embodiments of the present disclosure are not limited to the effects mentioned above, and other effects not mentioned can be clearly derived and understood by those skilled in the art to which the technical configuration of the present disclosure is applied from the description of the embodiments of the present disclosure below. That is, unintended effects resulting from implementing the configuration described in the present disclosure may also be derived by those skilled in the art from the embodiments of the present disclosure.

### BRIEF DESCRIPTION OF THE DRAWINGS

The drawings attached below are provided to help understand the present disclosure, and may provide embodiments of the present disclosure together with detailed description. However, the technical features of the present disclosure are not limited to specific drawings, and the features disclosed in each drawing may be combined with each other to constitute a new embodiment. Reference numerals in each drawing may indicate structural elements.

FIG. 1 illustrates an example of a communication system applied to the present disclosure.

FIG. 2 illustrates an example of a UE applicable to the present disclosure.

FIG. 3 illustrates an example of functional separation between NG-RAN and 5th generation core (5GC) applicable to the present disclosure.

FIG. 4 illustrates an example of general architecture of a 5th generation (5G) system applicable to the present disclosure.

FIG. 5 shows an example of a UE operation procedure according to an embodiment of the present disclosure.

### MODE FOR INVENTION

The following embodiments are combinations of components and features of the present disclosure in predetermined forms. Each component or feature may be considered optional unless explicitly stated otherwise. Each component or feature may be implemented without being combined with other components or features. Also, an embodiment of the present disclosure may be configured by combining some components and/or features. The order of operations described in the embodiments of the present disclosure may be changed. Some configurations or features of one embodiment may be included in another embodiment, or may be replaced with corresponding configurations or features of another embodiment.

In the description of the drawings, procedures or steps that may obscure the gist of the present disclosure are not described, and procedures or steps that can be understood at the level of those skilled in the art are also not described.

Throughout the specification, when a part is said to “comprise” or “include” a component, this means that it may further include other components rather than excluding other components unless specifically stated to the contrary. Also, terms such as “unit”, “device”, and “module” described in the specification mean a unit that processes at least one function or operation, which may be implemented by hardware, software, or a combination of hardware and software. Also, “a” or “an”, “one”, “the” and similar related words may be used in a sense including both singular and plural in the context of describing the present disclosure (particularly in the context of the claims below) unless otherwise indicated herein or clearly contradicted by context.

In this specification, the embodiments of the present disclosure have been described focusing on the data transmission and reception relationship between a base station and a mobile station. Here, the base station has meaning as a terminal node of a network that directly communicates with a mobile station. Specific operations described as being performed by a base station in this document may in some cases be performed by an upper node of the base station.

That is, various operations performed for communication with a mobile station in a network consisting of multiple network nodes including a base station may be performed by the base station or other network nodes other than the base station. At this time, ‘base station’ may be replaced by terms such as fixed station, Node B, eNB (eNode B), gNB (gNode B), ng-eNB, advanced base station (ABS), or access point.

Also, in the embodiments of the present disclosure, a terminal may be replaced by terms such as user equipment (UE), mobile station (MS), subscriber station (SS), mobile subscriber station (MSS), mobile terminal, or advanced mobile station (AMS).

Also, a transmitting end refers to a fixed and/or mobile node that provides data service or voice service, and a receiving end refers to a fixed and/or mobile node that receives data service or voice service. Therefore, in the case of uplink, a mobile station may be a transmitting end and a base station may be a receiving end. Similarly, in the case of downlink, a mobile station may be a receiving end and a base station may be a transmitting end.

The embodiments of the present disclosure may be supported by standard documents disclosed in at least one of wireless access systems including IEEE 802.xx system, 3rd Generation Partnership Project (3GPP) system, 3GPP Long Term Evolution (LTE) system, 3GPP 5th generation (5G) New Radio (NR) system, and 3GPP2 system, and in particular, the embodiments of the present disclosure may be supported by 3GPP technical specification (TS) 38.211, 3GPP TS 38.212, 3GPP TS 38.213, 3GPP TS 38.321, and 3GPP TS 38.331 documents.

Also, the embodiments of the present disclosure may be applied to other wireless access systems and are not limited to the above-described systems. For example, they may be applicable to systems applied after the 3GPP 5G NR system and are not limited to a specific system.

That is, obvious steps or parts not described among the embodiments of the present disclosure may be described with reference to the above documents. Also, all terms disclosed in this document may be described by the above standard documents.

Hereinafter, preferred embodiments according to the present disclosure will be described in detail with reference to the accompanying drawings. The detailed description to be disclosed below together with the accompanying drawings is intended to describe exemplary embodiments of the present disclosure and is not intended to represent the only embodiment in which the technical configuration of the present disclosure may be implemented.

Also, specific terms used in the embodiments of the present disclosure are provided to help understanding of the present disclosure, and the use of such specific terms may be changed to other forms without departing from the technical spirit of the present disclosure.

The following technology may be applied to various wireless access systems such as code division multiple access (CDMA), frequency division multiple access (FDMA), time division multiple access (TDMA), orthogonal frequency division multiple access (OFDMA), single carrier frequency division multiple access (SC-FDMA), and the like.

For clarity of description below, the description is based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” means a standard document detail number. LTE/NR/6G may be collectively referred to as a 3GPP system.

Regarding background technology, terms, abbreviations, etc., used in the present disclosure, reference may be made to matters described in standard documents published before the present disclosure. For example, 36.xxx and 38.xxx standard documents may be referred to.

For terms, abbreviations, and other background technologies that may be used in this document, reference may be made to the following standard document descriptions published before this document. In particular, for LTE/Evolved Packet System (EPS) related terms, abbreviations, and other background technologies, reference may be made to 36.xxx series, 23.xxx series, and 24.xxx series, and for new radio (NR)/5G system (5GS) related terms, abbreviations, and other background technologies, reference may be made to 38.xxx series, 23.xxx series, and 24.xxx series.

Hereinafter, this specification is described based on the terms defined as above.

The three main requirement areas of 5G include (1) Enhanced Mobile Broadband (eMBB) area, (2) massive Machine Type Communication (mMTC) area, and (3) Ultra-reliable and Low Latency Communications (URLLC) area.

Some use cases may require multiple areas for optimization, and other use cases may focus only on one Key Performance Indicator (KPI). 5G supports these various use cases in a flexible and reliable way.

### Communication System Applicable to the Present Disclosure

Although not limited thereto, various descriptions, functions, procedures, proposals, methods and/or operational flowcharts of the present disclosure disclosed in this document may be applied to various fields requiring wireless communication/connection (e.g., 5G) between devices.

Hereinafter, more specific examples are illustrated with reference to drawings. In the following drawings/descriptions, the same reference numerals may illustrate the same or corresponding hardware blocks, software blocks, or functional blocks unless described otherwise.

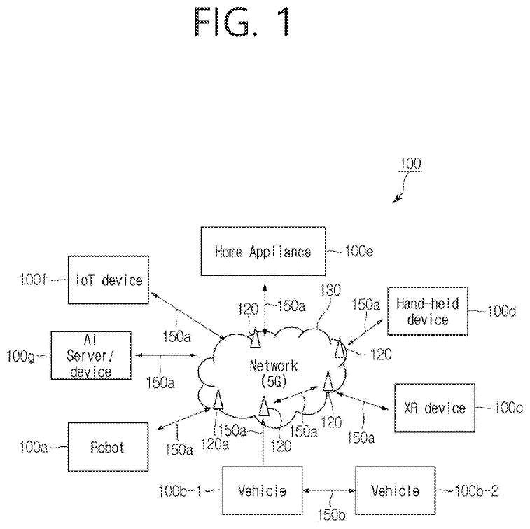

FIG. 1 illustrates an example of a communication system applied to the present disclosure.

Referring to FIG. 1, a communication system 100 applied to the present disclosure includes wireless devices, a base station, and a network. Here, a wireless device means a device that performs communication using wireless access technology (e.g., 5G NR, LTE), and may be referred to as a communication/wireless/5G device. Although not limited thereto, the wireless device may include a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 100g. For example, the vehicle may include a vehicle equipped with wireless communication function, an autonomous vehicle, a vehicle capable of performing vehicle-to-vehicle communication, etc. Here, the vehicles 100b-1 and 100b-2 may include an unmanned aerial vehicle (UAV) (e.g., drone). The XR device 100c includes augmented reality (AR)/virtual reality (VR)/mixed reality (MR) devices, and may be implemented in the form of a head-mounted device (HMD), a head-up display (HUD) installed in a vehicle, television, smartphone, computer, wearable device, home appliance, digital signage, vehicle, robot, etc. The hand-held device 100d may include a smartphone, smart pad, wearable device (e.g., smartwatch, smart glasses), computer (e.g., laptop, etc.), etc. The home appliance 100e may include TV, refrigerator, washing machine, etc. The IoT device 100f may include a sensor, smart meter, etc. For example, the base station 120 and network 130 may also be implemented as wireless devices, and a specific wireless device 120a may operate as a base station/network node for other wireless devices.

The wireless devices 100a to 100f may be connected to the network 130 through the base station 120. AI technology may be applied to the wireless devices 100a to 100f, and the wireless devices 100a to 100f may be connected to an AI server 100g through the network 130. The network 130 may be configured using a 3G network, 4G (e.g., LTE) network, or 5G (e.g., NR) network, etc. The wireless devices 100a to 100f may communicate with each other through the base station 120/network 130, but may also communicate directly (e.g., sidelink communication) without going through the base station 120/network 130. For example, the vehicles 100b-1 and 100b-2 may perform direct communication (e.g., vehicle to vehicle (V2V)/vehicle to everything (V2X) communication). Also, the IoT device 100f (e.g., sensor) may communicate directly with other IoT devices (e.g., sensor) or other wireless devices 100a to 100f.

Wireless communication/connection 150a, 150b, and 150c may be established between the wireless devices 100a to 100f/base station 120 and between base stations 120/120. Here, wireless communication/connection may be achieved through various wireless access technologies (e.g., 5G NR) such as uplink/downlink communication 150a, sidelink communication 150b (or D2D communication), and inter-base station communication 150c (e.g., relay, integrated access backhaul (IAB)). Through wireless communication/connection 150a, 150b, and 150c, wireless devices and base stations/wireless devices, and base stations and base stations may transmit/receive wireless signals to/from each other. For example, wireless communication/connection 150a, 150b, and 150c may transmit/receive signals through various physical channels. To this end, based on various proposals of the present disclosure, at least some of various configuration information setting processes for wireless signal transmission/reception, various signal processing processes (e.g., channel encoding/decoding, modulation/demodulation, resource mapping/demapping, etc.), resource allocation processes, etc., may be performed.

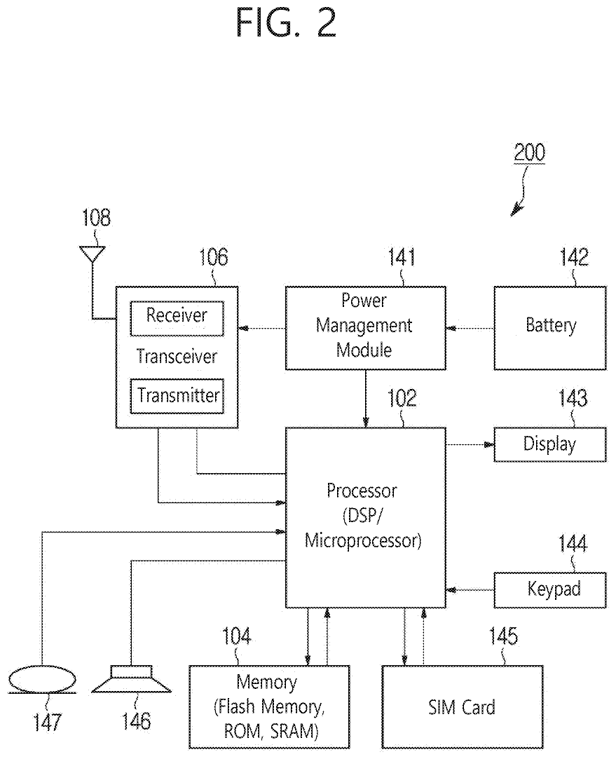

FIG. 2 illustrates an example of a UE applicable to the present disclosure.

Referring to FIG. 2, the UE 200 may include a processor 102, memory 104, transceiver 106, one or more antennas 108, power management module 141, battery 142, display 143, keypad 144, Subscriber Identification Module (SIM) card 145, speaker 146, and microphone 147.

The processor 102 may be configured to implement the descriptions, functions, procedures, proposals, methods and/or operational flowcharts disclosed herein. The processor 102 may be configured to control one or more other components of the UE 200 to implement the descriptions, functions, procedures, proposals, methods and/or operational flowcharts disclosed herein. Layers of wireless interface protocol may be implemented in the processor 102. The processor 102 may include ASIC, other chipset, logic circuit and/or data processing device. The processor 102 may be an application processor. The processor 102 may include at least one of DSP, Central Processing Unit (CPU), Graphics Processing Unit (GPU), and modem (modulator and demodulator).

The memory 104 is operably coupled with the processor 102 and may store various information for operating the processor 102. The memory 104 may include ROM, RAM, flash memory, memory card, storage medium and/or other storage device. When implementation is implemented in software, the techniques described herein may be implemented using modules (e.g., procedures, functions, etc.) that perform the descriptions, functions, procedures, proposals, methods and/or operational flowcharts disclosed herein. The modules may be stored in memory 14 and executed by the processor 102. The memory 104 may be implemented within the processor 102 or external to the processor 102, in which case it may be communicatively coupled with the processor 102 through various methods known in the art.

The transceiver 106 is operably coupled with the processor 102 and may transmit and/or receive wireless signals. The transceiver 106 may include a transmitter and a receiver. The transceiver 106 may include baseband circuitry for processing radio frequency signals. The transceiver 106 may control one or more antennas 108 to transmit and/or receive wireless signals.

The power management module 141 may manage power for the processor 102 and/or transceiver 106. The battery 142 may supply power to the power management module 141.

The display 143 may output results processed by the processor 102. The keypad 144 may receive input for use by the processor 102. The keypad 144 may be displayed on the display 143.

The SIM card 145 is an integrated circuit for securely storing International Mobile Subscriber Identity (IMSI) and related keys, and may be used to identify and authenticate subscribers in mobile phone devices such as mobile phones or computers. Also, contact information may be stored in many SIM cards.

The speaker 146 may output sound-related results processed by the processor 102. The microphone 147 may receive sound-related input for use by the processor 102.

In implementation of this specification, the UE may operate as a transmitting device in uplink and as a receiving device in downlink. In implementation of this specification, the base station may operate as a receiving device in UL and as a transmitting device in DL. In this specification, the base station may be called Node B, eNode B (eNB), gNB, and may not be limited to a specific form.

Also, for example, the UE may be implemented in various forms according to use cases/services. The UE may be configured by various components, devices/parts and/or modules. For example, each UE may include a communication device, control device, memory device, and additional components. The communication device may include communication circuitry and a transceiver. For example, the communication circuitry may include one or more processors and/or one or more memories. For example, the transceiver may include one or more transceivers and/or one or more antennas. The control device is electrically connected to the communication device, memory device, and additional components, and may control the overall operation of each UE. For example, the control device may control the electrical/mechanical operation of each UE based on programs/codes/instructions/information stored in the memory device. The control device may transmit information stored in the memory device to the outside (e.g., other communication devices) through the communication device via wireless/wired interface, or store information received from the outside (e.g., other communication devices) through the communication device via wireless/wired interface in the memory device.

The additional components may be configured variously according to the type of UE. For example, the additional components may include at least one of power device/battery, input/output (I/O) device (e.g., audio I/O port, video I/O port), driving device, and computing device. Also, the UE may be implemented in the form of, but not limited to, robot (100a in FIG. 1), vehicle (100b-1 and 100b-2 in FIG. 1), XR device (100c in FIG. 1), portable device (100d in FIG. 1), home appliance (100e in FIG. 1), IoT device (100f in FIG. 1), digital broadcasting terminal, hologram device, public safety device, MTC device, medical device, fintech device (or financial device), security device, climate/environment device, AI server/device (100g in FIG. 1), base station (120 in FIG. 1), network node. The UE may be used in mobile or fixed locations according to use cases/services.

All of the various components, devices/parts and/or modules of the UE may be connected to each other through wired interface, or at least some may be wirelessly connected through the communication device. Also, each component, device/part and/or module of the UE may further include one or more elements. For example, the control device may be configured by one or more processor sets. For example, the control device may be configured by a set of communication control processor, Application Processor (AP), Electronic Control Unit (ECU), graphics processing unit, and memory control processor. As another example, the memory device may be configured by RAM, Dynamic RAM (DRAM), ROM, flash memory, volatile memory, non-volatile memory and/or combinations thereof.

### 5G System Architecture Applicable to the Present Disclosure

The 5G system is an advanced technology from 4th generation LTE mobile communication technology that supports new Radio Access Technology (RAT), extended LTE (eLTE) as an extended technology of Long Term Evolution (LTE), non-3GPP (e.g., WLAN) access, etc., through evolution or clean-state structure of existing mobile communication network structure.

The 5G system is defined service-based, and interactions between Network Functions (NFs) within the architecture for the 5G system can be represented in two ways as follows:
Reference point representation: Represents interactions between NF services within NFs described by point-to-point reference points (e.g., N11) between two NFs (e.g., AMF and SMF).
Service-based representation: Network functions (e.g., AMF) within the Control Plane (CP) allow other authorized network functions to access their services. This representation also includes point-to-point reference points when necessary.

5G Core (5GC) may include various components, among which access and mobility management function (AMF), session management function (SMF), policy control function (PCF), user plane function (UPF), application function (AF), unified data management (UDM), and non-3GPP interworking function (N3IWF) are included.

The UE is connected to a data network through UPF via next generation radio access network (NG-RAN) including gNB. The UE may receive data service through untrusted non-3GPP access, such as wireless local area network (WLAN). To connect non-3GPP access to the core network, N3IWF may be deployed.

N3IWF performs the function of managing interworking between non-3GPP access and the 5G system. When the UE is connected to non-3GPP access (e.g., WiFi referred to as IEEE 802.11), the UE may be connected to the 5G system through N3IWF. N3IWF performs control signaling with AMF and is connected to UPF through N3 interface for data transmission.

AMF may manage access and mobility in the 5G system. AMF may perform the function of managing non-access stratum (NAS) security. AMF may perform the function of handling mobility in idle state.

UPF performs the function of a gateway for transmitting and receiving user data. The UPF node may perform all or part of the user plane functions of serving gateway (S-GW) and packet data network gateway (P-GW) of 4th generation mobile communication.

UPF operates as a boundary point between next generation RAN (NG-RAN) and core network, and is an element that maintains data path between gNB and SMF. Also, when the UE moves across an area served by gNB, UPF performs the role of mobility anchor point. UPF may perform the function of handling PDU. For mobility within NG-RAN (e.g., NG-RAN defined after 3GPP Release-15), UPF may route packets. Also, UPF may function as an anchor point for mobility with other 3GPP networks (e.g., RAN defined before 3GPP Release-15), for example, UMTS (universal mobile telecommunications system) terrestrial radio access network (UTRAN), evolved-UTRAN (E-UTRAN), or GSM (global system for mobile communication)/EDGE (enhanced data rates for global evolution) radio access network (GERAN). UPF may correspond to a termination point of data interface toward data network.

PCF is a node that controls operator policy. AF is a server for providing various services to the UE. UDM is a server that manages subscriber information, like home subscriber server (HSS) of 4th generation mobile communication. UDM 460 stores and manages subscriber information in unified data repository (UDR).

SMF may perform the function of allocating Internet protocol (IP) address of the UE. And SMF may control protocol data unit (PDU) session.

For convenience of description below, reference numerals for AMF, SMF, PCF, UPF, AF, UDM, N3IWF, gNB, or UE may be omitted, and may operate with reference to matters described in standard documents published before this document.

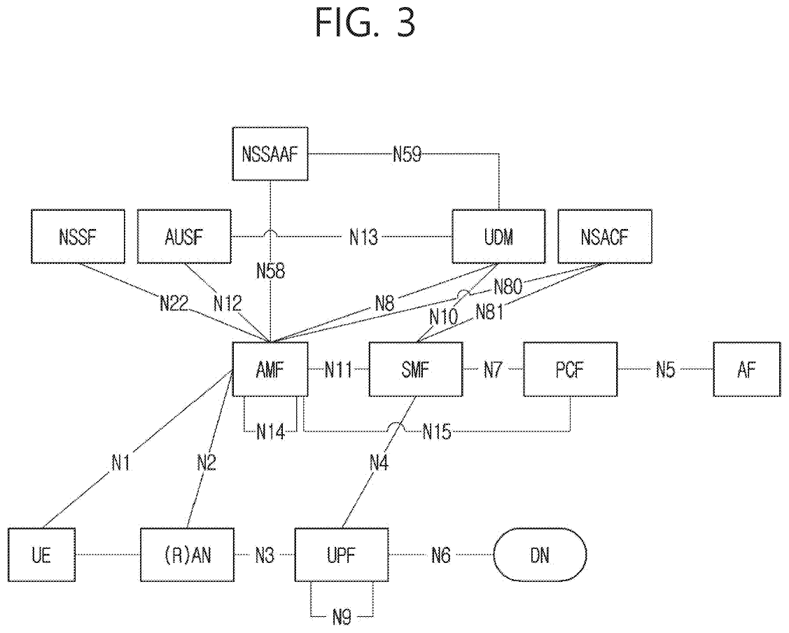

FIG. 3 illustrates an example of functional separation between NG-RAN and 5th generation core (5GC) applicable to the present disclosure.

Referring to FIG. 3, the UE is connected to a data network (DN) through next generation RAN. The control plane function (CPF) node performs all or part of the functions of mobility management entity (MME) of 4th generation mobile communication, and all or part of the control plane functions of serving gateway (S-GW) and PDN gateway (P-GW). The CPF node includes AMF and SMF.

The UPF node performs the function of a gateway through which user data is transmitted and received.

Authentication server function (AUSF) authenticates and manages the UE. Network Slice Selection Function (NSSF) is a node for network slicing as described below.

Network exposure function (NEF) provides a mechanism to securely expose services and functions of 5G core.

The reference points shown in FIG. 3 are as follows. N1 represents a reference point between UE and AMF. N2 represents a reference point between (R)AN and AMF. N3 represents a reference point between (R)AN and UPF. N4 represents a reference point between SMF and UPF. N5 represents a reference point between PCF and AF. N6 represents a reference point between UPF and DN. N7 represents a reference point between SMF and PCF. N8 represents a reference point between UDM and AMF. N9 represents a reference point between UPFs. N10 represents a reference point between UDM and SMF. N11 represents a reference point between AMF and SMF. N12 represents a reference point between AMF and AUSF. N13 represents a reference point between UDM and AUSF. N14 represents a reference point between AMFs. N15 represents a reference point between PCF and AMF in non-roaming scenario, and a reference point between AMF and PCF of visited network in roaming scenario. N16 represents a reference point between SMFs. N22 represents a reference point between AMF and NSSF. N30 represents a reference point between PCF and NEF. N33 may represent a reference point between AF and NEF, and the above-mentioned entities and interfaces may be configured with reference to matters described in standard documents published before this document. N58 represents a reference point between AMF and NSSAAF. N59 represents a reference point between UDM and NSSAAF. N80 represents a reference point between AMF and NSACF. N81 represents a reference point between SMF and NSACF.

The wireless interface protocol is based on 3GPP radio access network specifications. The wireless interface protocol consists horizontally of physical layer, data link layer, and network layer, and is vertically divided into user plane for data information transmission and control plane for control signal (signaling) transmission.

Protocol layers can be divided into L1 (layer-1), L2 (layer-2), and L3 (layer-3) based on the lower three layers of the open system interconnection (OSI) reference model widely known in communication systems.

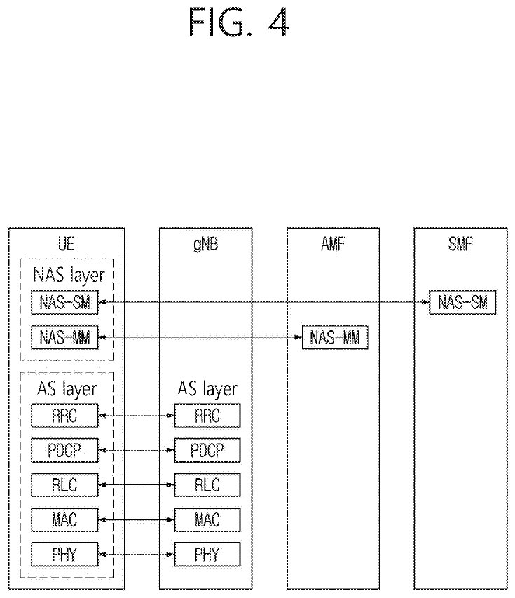

Hereinafter, the present disclosure describes each layer of wireless protocol. FIG. 4 illustrates an example of general architecture of a 5th generation (5G) system applicable to the present disclosure.

Referring to FIG. 4, the access stratum (AS) layer may include physical (PHY) layer, medium access control layer, radio link control (RLC) layer, packet data convergence protocol (PDCP) layer, and radio resource control (RRC) layer, and operations based on each layer may operate with reference to matters described in standard documents published before this document.

### SPECIFIC EMBODIMENTS OF THE PRESENT DISCLOSURE

The present disclosure relates to selecting a Public Land Mobile Network (PLMN) in a wireless communication system. Specifically, the present disclosure relates to a device and method for determining whether a signal level enhanced network selection (SENSE) is applicable for the UE based on whether an access technology related to a signal threshold is supported, and performing PLMN selection based on the SENSE applicability.

The UE may acquire system information broadcasted from a base station and may select and camp on a suitable cell. Thereafter, the UE may obtain service-based configuration information and may connect to a network. For example, a Public Land Mobile Network (PLMN) may be composed of an Mobile Country Code (MCC) and an Mobile Network Code (MNC). Here, a Home PLMN (HPLMN) may be a PLMN defined for the UE, and a Visited PLMN (VPLMN) may be a PLMN based on the current location of the UE. In addition, an Equivalent HPLMN (EHPLMN) may refer to a PLMN equivalent to the HPLMN, and a list thereof may be stored in the UE's Universal Subscriber Identity Module (USIM). The UE may select a PLMN with a higher priority, and PLMN selection may be performed in either automatic mode or manual mode.

Specifically, when the UE is turned on or returns from an out-of-service coverage area to a service-available coverage area, the UE may perform PLMN selection. The UE may preferentially select the last registered PLMN, or may select a PLMN in the HPLMN or EHPLMN list, and then may register with the network. If the UE cannot connect to the HPLMN or EHPLMN, UE may select another PLMN based on priority information stored in the USIM. That is, the UE may select a PLMN based on the priority information for PLMNs.

For example, when selecting a PLMN based on the automatic mode, the UE may automatically select a PLMN based on a pre-configured priority. Specifically, the UE may automatically select PLMNs in the order of HPLMN, EHPLMN, User PLMN (UPLMN), and other PLMNs, but not limited thereto. In another example, when selecting a PLMN based on the manual mode, the UE may display a list of accessible PLMNs and perform an establishment procedure with the selected PLMN. In this case, it may also be possible to select a forbidden PLMN based on the PLMN selection, and if registration is successfully performed, the corresponding PLMN may no longer be considered forbidden.

In addition, for example, when selecting a PLMN based on roaming, the UE may receive service from a VPLMN rather than an HPLMN. For example, the UE may be registered in a PLMN outside the coverage of the HPLMN (e.g., in another country) based on information stored in the USIM. The UE may periodically search for the HPLMN, but the proposed technique is not limited thereto.

Furthermore, with respect to PLMN selection of a roaming UE, steering of roaming (SOR) refers to updating, in the control plane, the combinations of PLMN/access technology preferred by the HPLMN. The UE may receive the preferred PLMN/access technology combinations, and may select a PLMN based on the received PLMN/access technology list. That is, the operator-controlled PLMN selector with access technology priority in the corresponding access technology may be changed to the received PLMN list.

The following [Table 1] shows a procedure related to PLMN selection, excerpted from TS 23.122 v18.2.0.

TABLE 1
4.4.3 PLMN selection
The registration on the selected PLMN and the location registration are only necessary if the MS is capable of
services which require registration. Otherwise, the PLMN selection procedures are performed without registration.
The ME shall utilise all the information stored in the SIM related to the PLMN selection; e.g. “HPLMN Selector
with Access Technology”, “User Controlled PLMN Selector with Access Technology”, “Forbidden PLMNs”,
“Equivalent HPLMN”, see 3GPP TS 31.102 [40]. The ME shall also utilise the extension of the “forbidden
PLMNs” list that it has stored locally on the ME if available.
The ME shall either utilise the “Operator controlled PLMN Selector with Access Technology” that it has stored
locally on the ME, or the Operator controlled PLMN Selector with Access Technology” stored in the SIM, for the
purposes of PLMN selection.
The “HPLMN Selector with Access Technology”, “User Controlled PLMN Selector with Access Technology”
and “Operator Controlled PLMN Selector with Access Technology” data files in the SIM include associated access
technologies for each PLMN entry, see 3GPP TS 31.102 [40]. The PLMN/access technology combinations are
listed in priority order. If an entry indicates more than one access technology, then no priority is defined for the
access technologies within this entry and the priority applied to each access technology within this entry is an
implementation issue. If no particular access technology is indicated in an entry, it shall be assumed that all access
technologies supported by the ME apply to the entry. If an entry only indicates access technologies not supported
by the ME, the entry shall be ignored. If an entry indicates at least one access technology supported by the ME,
the entry shall be used in the PLMN selection procedures if the other criteria defined for the specific PLMN
selection procedures are fulfilled.
The Mobile Equipment stores a list of “equivalent PLMNs”. This list is replaced or deleted at the end of each
location update procedure, routing area update procedure, GPRS attach procedure, tracking area update procedure,
EPS attach procedure, and registration procedure. The list is deleted by an MS attached for emergency bearer
services or for access to RLOS after detach or registered for emergency services after de-registration. The stored
list consists of a list of equivalent PLMNs as downloaded by the network plus the PLMN code of the registered
PLMN that downloaded the list. All PLMNs in the stored list, in all access technologies supported by the PLMN,
are regarded as equivalent to each other for PLMN selection, cell selection/re-selection and handover.
When the MS reselects to a cell in a shared network, and the cell is a suitable cell for multiple PLMN identities
received on the BCCH or on the BC-BCCH the AS indicates these multiple PLMN identities to the NAS according
to 3GPP TS 44.018 [34], 3GPP TS 44.060 [39], 3GPP TS 25.304 [32], 3GPP TS 36.304 [43] and
3GPP TS 38.304 [61]. The MS shall choose one of these PLMNs. If the registered PLMN is available among
these PLMNs, the MS shall not choose a different PLMN.
The MS shall not use the PLMN codes contained in the “HPLMN Selector with Access Technology” data file.
It is possible for the home network operator to identify alternative Network IDs as the HPLMN. If the EHPLMN
list is present, and not empty, the entries in the EHPLMN list are used in the network selection procedures. When
attempting to select a network the highest priority EHPLMN that is available shall be selected. If the EHPLMN
list is present and is empty or if the EHPLMN list is not present, the HPLMN derived from the IMSI is used for
network selection procedures.

| | |
|---|---|
| NOTE 1: | The “HPLMN Selector with Access Technology” data file is only used by the MS to get the HPLMN |
| | access technologies related to the HPLMN code which corresponds to the PLMN code included in |
| | the IMSI if the EHPLMN list is not present or is empty. If the EHPLMN list is present then this |
| | data field is applicable to all the entries within the EHPLMN list. |
| NOTE 2: | Different GSM frequency bands (e.g. 900, 1800, 1900, 400) are all considered GSM access |
| | technology. An MS supporting more than one band should sean all the bands it's supports when |
| | scanning for GSM frequencies. However GSM COMPACT systems which use GSM frequency |
| | bands but with the CBPCCH broadcast channel are considered as a separate access technology from |
| | GSM. |
| NOTE 3: | The inclusion of the HPLMN derived from the IMSI in the EHPLMN list is allowed. The priority |
| | of the HPLMN derived from the IMSI is given by its position in the EHPLMN list, see |
| | 3GPP TS 31.102 [40]. |

The MS may support minimization of service interruption (MINT).

Referring to [Table 1], when performing PLMN selection, the UE selects the PLMN with the highest possible priority.

However, when a stationary IoT UE at a specific position performs PLMN selection based on priority, even if there are PLMNs with strong received signal strengths at that location, there may be cases where a high priority PLMN is continuously selected even though registration is impossible or data connection cannot be maintained even if registration succeeds due to significantly weak received signal strength. In this case, the stationary IoT UE may be unable to perform data transmission for an extended period of time. Accordingly, an enhanced PLMN (Public Land Mobile Network) selection method is being studied by the 3GPP Technical Specification Group Core Network and Terminals (TSG CT) 1 group through the Signal Level Enhanced Network Selection (SENSE) Work Item Description (WID). The enhanced PLMN selection method, referred to as the SENSE technique, allows the UE to select a PLMN whose received signal strength exceeds a certain signal threshold, regardless of the priority. In addition, a PLMN selection method for UEs to which the SENSE technique is applicable is being discussed.

[Table 2] shows a procedure related to PLMN selection during switch-on or coverage recovery, as excerpted from TS 23.122 v18.2.0.

TABLE 2
4.4.3.1 At switch on or recovery from lack of coverage
At switch on, following recovery from lack of coverage, or when the MS stops operating in the SNPN access
mode:

| a) | if signal level enhanced network selection is not applicable (see clause 3.11) or when referring to case x) | |
|---|---|---|
| | of clause 4.4.3.1.1, the MS selects the registered PLMN or equivalent PLMN (if it is available) using all | |
| | access technologies that the MS is capable of without considering the “Operator controlled signal threshold | |
| | per access technology” stored in the USIM; or | |
| b) | if: | |
| | - | signal level enhanced network selection is applicable (see clause 3.11); and |
| | - | the received signal quality from a candidate PLMN/access technology combination comprising of a |
| | | registered PLMN or an equivalent PLMN (if it is available) is equal to or greater than the “Operator |
| | | controlled signal threshold per access technology” of the access technology configured in the USIM. |

the MS shall select the registered PLMN or equivalent PLMN (if it is available) and the access technology
for which the received signal quality is equal to or greater than the “Operator controlled signal threshold
per access technology” stored in the USIM. If for the registered PLMN or equivalent PLMN there are two
or more access technologies for which the received signal quality is equal to or greater than the “Operator
controlled signal threshold per access technology” stored in the USIM, it is up to implementation which
access technology is selected by the MS.

and if necessary (in the case of recovery from lack of coverage, see clause 4.5.2) attempts to perform a Location
Registration.

| NOTE 1: | The MS in automatic network selection mode can end the PLMN search procedure once the |
|---|---|
| | registered PLMN or equivalent PLMN is found on an access technology. |
| NOTE 2: | An MS in automatic network selection mode can use location information to determine which |
| | PLMNs can be available in its present location. |

EXCEPTION: As an alternative option to this, if the MS is in automatic network selection mode and it finds
coverage of an EHPLMN, the MS may register to that EHPLMN and not return to the registered PLMN or
equivalent PLMN. If the EHPLMN list is not present or is empty, and the HPLMN is available, the MS may
register on the HPLMN and not return to the registered PLMN or equivalent PLMN. The operator shall be able
to control by SIM configuration whether an MS that supports this option is permitted to perform this alternative
behaviour.
EXCEPTION: As an alternative option to this, if the MS is in automatic network selection mode, the MS has a
list of “PLMNs where registration was aborted due to SOR” and the registered PLMN is part of the list of “PLMNs
where registration was aborted due to SOR”, the MS may choose not to return to the registered PLMN or
equivalent PLMN and proceed as defined in clause 4.4.3.1.1 with the exception that in iii), the MS considers
PLMNs which are in the list of “PLMNs where registration was aborted due to SOR” as lowest priority.
EXCEPTION: In A/Gb mode an MS with voice capability, shall not search for CPBCCH carriers. In A/Gb mode
an MS not supporting packet services shall not search for CPBCCH carriers.
If successful registration is achieved, the MS indicates the selected PLMN.
If:

| | |
|---|---|
| - | there is no registered PLMN; |
| - | registration is not possible due to the PLMN being unavailable or registration failure; or |
| - | signal level enhanced network selection is applicable (see clause 3.11) or when referring to case x) of |
| | clause 4.4.3.1.1, and the received signal quality of all access technologies (if the MS is capable of and if it |
| | is available) from the registered PLMN or equivalent PLMN (if available) is lower than the “Operator |
| | controlled signal threshold per access technology” stored in the USIM of the corresponding access |
| | technology. |

the MS follows one of the following two procedures depending on its PLMN selection operating mode. At switch
on, if the MS provides the optional feature of user preferred PLMN selection operating mode at switch on then
this operating mode shall be used. Otherwise, the MS shall use the PLMN selection mode that was used before
switching off.
EXCEPTION: At switch on, if the MS is in manual mode and neither registered PLMN nor PLMN that is
equivalent to it is available, but EHPLMN is available, then instead of performing the manual network selection
mode procedure of clause 4.4.3.1.2 the MS may select and attempt registration on the highest priority EHPLMN.
If the EHPLMN list is not available or is empty and the HPLMN is available, then the MS may select and attempt
registration on the HPLMN. If the MS supports CAG and needs to select or attempt registration on the highest
priority EHPLMN or HPLMN, the MS follows network selection procedures of clause 4.4.3.1.1 bullet m). The
MS shall remain in manual mode.

| NOTE 3: | If successful registration is achieved, then the current serving PLMN becomes the registered PLMN |
|---|---|
| | and the MS does not store the previous registered PLMN for later use. |

EXCEPTION: If registration is not possible on recovery from lack of coverage due to registered PLMN being
unavailable, an MS attached to GPRS services, attached via E-UTRAN or registered via the NG-RAN may,
optionally, continue looking for the registered PLMN for an implementation dependent time.

| NOTE 4: | An MS attached to GPRS services, attached via E-UTRAN or registered via the NG-RAN should |
|---|---|
| | use the above exception only if one or more PDP contexts, PDN connections or PDU sessions are |
| | currently active. |

EXCEPTION: At switch on, if the RPLMN is a PLMN with which the MS was registered for disaster roaming
services and the MS is registered via non-3GPP access connected to 5GCN or an NG-RAN cell of the RPLMN
broadcasts neither the disaster related indication nor a “list of one or more PLMN(s) with disaster condition for
which disaster roaming services is offered by the available PLMN” including the MS determined PLMN with
disaster condition or an allowable PLMN is available then the MS will ignore RPLMN and its equivalent PLMN

As shown in [Table 2], the UE selects a PLMN based on the applicability of SENSE. Specifically, when SENSE is not applicable, the UE selects a PLMN by using all supported access technologies without considering the “Operator controlled signal threshold per access technology” stored in the USIM. On the other hand, when SENSE is applicable, the UE selects a PLMN by considering the “Operator controlled signal threshold per access technology” stored in the USIM. That is, the UE performs PLMN selection based on priority or signal strength depending on whether SENSE is applicable.

[Table 3] shows a procedure for determining whether SENSE is applicable, excerpted from TS 23.122 v18.2.0.

TABLE 3
3.11 Signal level enhanced network selection
Signal level enhanced network selection applies only to NB-IoT, GERAN EC-GSM-IoT and Category M1 or M2
of E-UTRA. An MS supporting any, or a combination, of NB-IoT, GERAN EC-GSM-IoT and Category M1 or
M2 of E-UTRA shall apply signal level enhanced network selection if the following conditions are fulfilled:

| | |
|---|---|
| 1) | The MS is in automatic PLMN selection mode; |
| 2) | The MS supports the “Operator controlled signal threshold per access technology” as specified in |
| | 3GPP TS 22.011 [19]; |
| 3) | The MS is configured for using signal level enhanced network selection as specified in |
| | 3GPP TS 24.368 [50]; and |
| 4) | The “Operator controlled signal threshold per access technology” is configured in the USIM. |
| NOTE 1: | The usage of the “Operator controlled signal threshold per access technology” is intended only for |
| | IoT stationary devices (see 3GPP TS 22.011 [19]). |
| NOTE 2: | “Operator controlled signal threshold per access technology” is not expected to be supported by |
| | non-IoT devices. |

```
The MS can be configured with an “Operator controlled signal threshold per access technology” stored in the
USIM (see 3GPP TS 31.102 [40]) consisting of one or more entries, each containing:
  a) a home operator controlled signal threshold; and
  b) an access technology.
The “Operator controlled signal threshold per access technology” is specific for a certain access technology and
when applicable, applies to all allowable PLMNs with the corresponding access technology combination.
Editor's note (WI SENSE, CR 0952): It is FFS whether HPLMN can use CP-SOR procedure to update the
signal level enhanced network selection in the USIM.
```

As shown in [Table 3], the UE determines that SENSE function is applicable when four conditions are satisfied. The four conditions may include a first condition indicating that the UE should be in automatic PLMN selection mode, a second condition indicating that the UE should support an operator-controlled signal threshold per access technology, a third condition indicating that the UE should be configured to use SENSE function, and a fourth condition indicating that an operator-controlled signal threshold per access technology should be configured in the universal subscriber identity module (USIM).

The operator-controlled signal strength per access technology is indicated by an EF_{OCST} file within the USIM.

According to the discussion in the 3GPP TSG CTI group, the EF_{OCST} file within the USIM has the structure shown in [Table 4] below.

TABLE 4

| | | |
|---|---|---|
| Identifier: ‘6F02’ | Structure: transparent | Optional |
| File size: X bytes, (X ≥ 1) | Update activity: low | |

Access Conditions:

| | |
|---|---|
| READ | PIN |
| UPDATE | ADM |
| ACTIVATE | ADM |
| DEACTIVATE | ADM |

| Bytes | Description | M/O | Length |
|---|---|---|---|
| 1 | SENSE enabled by operator | M | 1 |
| 2 − | “Operator controlled | M | X bytes |
| X + 1 | signal threshold per access | | |
| | technology” parameter TLV object | | |

As shown in [Table 4], the EF_{OCST} file includes information indicating whether the SENSE function is enabled by the operator, i.e., SENSE enabled by operator, and operator-controlled signal strength per access technology.

The Operator-controlled signal strength per access technology information indicated by the EF_{OCST} file has a structure shown in [Table 5] below.

TABLE 5

| Description | Value | M/O/C | Length (bytes) |
|---|---|---|---|
| Operator controlled signal threshold per | ‘80’ | M | 1 |
| access technology tag | | | |
| Length | 3n | M | Note |
| Access Technology 1 | — | C | 2 |
| Operator controlled signal threshold per | — | C | 1 |
| access technology 1 | | | |
| . . . | | | |
| Access Technology n | — | C | 2 |
| Operator controlled signal threshold per | — | C | 1 |
| access technology n | | | |

Note:
The length is coded according to ISO/IEC 8825-1 [35]

As shown in [Table 5], the Operator-controlled signal threshold per access technology includes an access technology and a value of the “Operator-controlled signal threshold per access technology” corresponding to the access technology.

As described above, the Operator-controlled signal threshold per access technology information not only indicates the value of the “Operator-controlled signal threshold per access technology” for each access technology, but also indicates the related access technology. For example, the EF_{OCST} file may be configured as shown in [Table 6].

TABLE 6
CASE 1: MS supporting only GERAN EC-GSM-IoT, not supporting NB-IoT and
Category M1 or M2 of E-UTRA
EF_{OCST}
{ SENSE enabled by operator : 1,
Number of list : 1
Access Technology : 00000000 (1^{st} octet), 10000100(2^{st} octet) : GSM
without EC-GSM-IoT }
CASE 2: MS supporting only NB-IoT, not supporting GERAN EC-GSM-IoT and
Category M1 or M2 of E-UTRA
EF_{OCST}
{ SENSE enabled by operator : 1,
Number of list : 1
Access Technology : 01100000 (1^{st} octet), 00000000(2^{st} octet) : E-UTRAN
in WB-S1 mode only }

As shown in [Table 6], the EF_{OCST} file may indicate access technology types related to IoT (e.g., NB-S1 mode, WB-S1 mode, etc.) as well as other access technology types (e.g., E-UTRAN in WB-S1 mode, GSM without EC-GSM-IoT, etc.). Here, the NB-S1 mode means that, in a multi-access system, the currently serving radio access network provides access to network services through E-UTRA by means of NB-IoT. The WB-S1 mode means that, in a multi-access system, the serving radio access network operates in S1 mode and does not operate in NB-S1 mode. In addition, EC-GSM-IoT is a feature that enables extended coverage operation of GSM for IoT.

If the UE supports narrow band (NB)-IoT, UE supports either NB-S1 mode or WB-S1 mode, which are access technology types related to IoT. In this case, the UE cannot be processed on a network that supports an access technology type other than the IoT-related access technology type. For example, if the UE is NB_IoT-capable and the access technology indicated in the EF_{OCST} file is E-UTRAN in WB-S1 mode, the UE cannot be processed on that network.

Therefore, when determining whether SENSE is applicable, it is necessary to take into account whether the UE supports the access technologies indicated by the EF_{OCST} file.

According to the current specification, when the four conditions in [Table 3] are satisfied, the UE is considered capable of applying the SENSE function. Specifically, according to the fourth condition in [Table 3], the UE checks whether an operator-controlled signal threshold per access technology is configured in the USIM to determine whether the SENSE function is applicable. However, it is not appropriate to determine whether the SENSE function is applicable based on whether an operator-controlled signal threshold per access technology is configured in the USIM. This is because the EF_{OCST} file in the USIM, which indicates the operator-controlled signal threshold for each access technology, contains information about the access technology coded as EF_{PLMNwACT}. Therefore, even if the operator-controlled signal threshold per access technology is configured in the USIM, a UE supporting a specific IoT-related access technology needs to verify that at least one of all access technologies indicated by the EF_{OCST} file is an IoT-related access technology.

Accordingly, in order to determine whether the SENSE function is applicable, the UE according to an embodiment of the present disclosure additionally checks whether at least one of the access technologies indicated by the EF_{OCST} file matches an access technology supported by the UE. If at least one of the access technologies indicated by the EF_{OCST} file matches an access technology supported by the UE, the UE determines that the SENSE function is applicable. On the other hand, if none of the access technologies indicated by the EF_{OCST} file matches an access technology supported by the UE, the UE determines that the SENSE function is not applicable.

For example, referring to CASE 1 and CASE 2 in [Table 4], the UEs in CASE 1 and CASE 2 are each determined to be not applicable for SENSE function.

In CASE 1, the UE supports only GERAN EC-GSM-IoT and does not support NB-IoT or Category M1 or M2 of E-UTRA. At this time, the access technology in the EF_{OCST} file is configured to GSM without Extended Coverage in GSM for Internet of Things (EC-GSM-IoT). In other words, the access technology of CASE 1 does not support EC-GSM-IoT. Therefore, the UE determines that the configuration in the EF_{OCST} file is invalid and determines that the SENSE function is not applicable.

In CASE 2, the UE supports only NB-IoT and does not support GERAN EC-GSM-IoT and category M1 or M2 of E-UTRA. The access technology is configured to E-UTRAN in WB-S1 mode only. That is, the access technology of CASE 2 does not support NB-N1 mode and WB-N1 mode, which are modes related to NB-IoT.

Therefore, the UE determines that the configuration of the EF_{OCST} file is invalid and determines that the SENSE function is not applicable. Here, NB-N1 mode means that the wireless access network currently in service in a multiple access system provides access to 5G network services through E-UTRA connected to 5GCN by NB-IoT. WB-N1 mode means that in a multiple access system, the system operates in N1 mode using E-UTRA connected to 5GCN and does not operate in NB-N1 mode.

As described above, the present disclosure proposes a method for verifying whether at least one of the access technologies indicated by the EF_{OCST} file in the USIM matches the access technology supported by the UE when the UE supports a specific IoT-related access technology, and determining whether to apply the SENSE function based on the verification result.

The current specification defines how to configure operator-controlled signal threshold per access technology stored in the USIM for a UE. Specifically, the current specification defines that the operator-controlled signal threshold per access technology information includes one or more threshold lists and information about the access technology. However, the specification does not address SENSE enabled by operator.

Therefore, the present disclosure proposes adding SENSE enabled by operator that indicates whether the SENSE function is enabled, to the operator-controlled signal threshold per access technology information. That is, the operator-controlled signal threshold per access technology information according to an embodiment of the present disclosure may include SENSE enabled by operator, a threshold list, and an access technology.

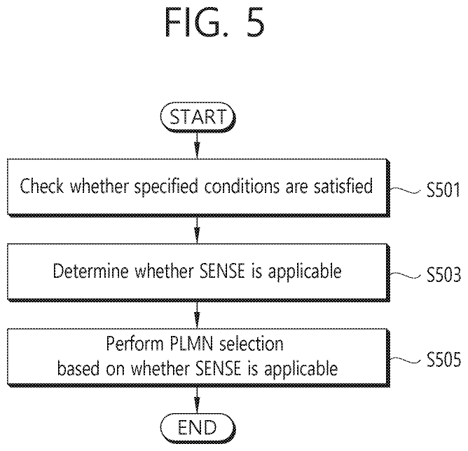

FIG. 5 shows an example of a UE operation procedure according to an embodiment of the present disclosure. FIG. 5 shows a method performed by a UE. In an embodiment, the UE may be a stationary Internet of Things (IoT) UE.

Referring to FIG. 5, in step S501, the UE checks whether specified conditions are satisfied. The specified conditions may include four conditions as shown in [Table 3], and an additional condition indicating that the UE should support an access technology related to a signal threshold configured in the USIM. For example, the UE may check whether all of the conditions described above are satisfied. According to an embodiment, whether the additional condition is satisfied may be checked based on information included in the operator-controlled signal threshold per access technology configured in the USIM. That is, the operator-controlled signal threshold per access technology configured in the USIM includes information indicating whether SENSE is enabled by the operator, a signal threshold controlled by the home operator, and information indicating an access technology related thereto. Accordingly, the UE may check whether the additional condition is satisfied by comparing the access technology indicated by the operator-controlled signal threshold per access technology configured in the USIM with the access technology supported by the UE.

In step S503, the UE determines whether SENSE is applicable. That is, the UE determines whether SENSE is applicable based on whether specified conditions are satisfied. According to an embodiment, when the first to fourth conditions and the additional condition described above are all satisfied, the UE may determine that SENSE is applicable. For example, when all of the first to fourth conditions are satisfied and additionally an additional condition that the UE supports an access technology corresponding to the signal threshold is satisfied, the UE may determine that SENSE is applicable. On the other hand, when at least one of the first to fourth conditions and the additional condition described above is not satisfied, the UE may determine that SENSE is not applicable. For example, even when the first to fourth conditions are satisfied, if an additional condition that the UE supports an access technology corresponding to the signal threshold is not satisfied, the UE may determine that SENSE is not applicable.

In step S505, the UE performs PLMN selection based on whether SENSE is applicable. That is, the UE performs PLMN selection based on the signal threshold or priority, depending on whether SENSE is applicable. For example, when SENSE is applicable, the UE may perform PLMN selection based on signal thresholds. Conversely, when SENSE is not applicable, the UE may perform PLMN selection based on priority.

According to embodiments of the present disclosure, the conditions that should be satisfied for SENSE application may be defined as shown in [Table 7] below.

TABLE 7
3.11 Signal level enhanced network selection
Signal level enhanced network selection applies only to NB-IoT, GERAN EC-GSM-IoT and Category M1 or M2
of E-UTRA. An MS supporting any, or a combination, of NB-IoT, GERAN EC-GSM-IoT and Category M1 or
M2 of E-UTRA shall apply signal level enhanced network selection if the following conditions are fulfilled:

| | |
|---|---|
| 1) | The MS is in automatic PLMN selection mode; |
| 2) | The MS supports the “Operator controlled signal threshold per access technology” as specified in |
| | 3GPP TS 22.011 [19]; |
| 3) | The MS is configured for using signal level enhanced network selection as specified in |
| | 3GPP TS 24.368 [50]; and |
| 4) | The “Operator controlled signal threshold per access technology” is configured in the USIM with “SENSE |
| | enable by operator” and one or more access technologies which can be applicable for associated IoT RAT. |
| NOTE 1: | The usage of the “Operator controlled signal threshold per access technology” is intended only for |
| | IoT stationary devices (see 3GPP TS 22.011 [19]). |
| NOTE 2: | “Operator controlled signal threshold per access technology” is not expected to be supported by |
| | non-IoT devices. |

The MS can be configured with an “Operator controlled signal threshold per access technology” stored in the
USIM (see 3GPP TS 31.102 [40]) consisting of a “SENSE enabled by operator” and one or more entries, each
containing:

| | |
|---|---|
| a) | a home operator controlled signal threshold; and |
| b) | an access technology. |

The “Operator controlled signal threshold per access technology” is specific for a certain access technology and
when applicable, applies to all allowable PLMNs with the corresponding access technology combination.
Editor's note (WI SENSE, CR 0952): It is FFS whether HPLMN can use CP-SOR procedure to

update the signal level enhanced network selection in the USIM.

Referring to [Table 6], the UE may determine whether the SENSE is applicable based on whether conditions 1) to 4) are satisfied. In particular, when an operator-controlled signal threshold per access technology is configured in the USIM, the UE may determine whether condition 4) is satisfied by checking the information included in the operator-controlled signal threshold per access technology. The operator-controlled signal threshold per access technology may include at least one of SENSE information enabled by the operator indicating whether the SENSE function is enabled by the operator, a signal threshold controlled by the home operator, and information on the access technology related to the signal threshold.

If the information of “SENSE enabled by operator” indicates that the SENSE function is enabled, and at least one of the access technologies related to the signal threshold corresponds to an access technology supported by the UE, condition 4) may be determined to be satisfied. On the other hand, if the information of “SENSE enabled by operator” indicates that the SENSE function is not enabled, or if all access technologies related to the signal threshold do not correspond to an access technology supported by the UE, condition 4) may be determined not to be satisfied.

When all of conditions 1) to 4) are satisfied, the UE may determine that the SENSE is applicable and may select a PLMN based on the signal threshold. In contrast, when at least one of conditions 1) to 4) is not satisfied, the UE may determine that the SENSE is not applicable and may select a PLMN based on priority.

Examples of the proposed methods described above can also be included as one of the implementation methods of the present disclosure, so it is clear that they can be considered as types of proposed methods. In addition, the proposed methods described above may be implemented independently, but may also be implemented in the form of a combination (or merger) of some proposed methods. Rules may be defined so that information on whether the proposed methods are applied (or information on the rules of the proposed methods) is notified by the base station to the terminal through a predefined signal (e.g., physical layer signal or higher layer signal).

The present disclosure may be embodied in other specific forms without departing from the technical ideas and essential features described in the present disclosure. Therefore, the above detailed description should not be interpreted as restrictive in all aspects but should be considered as illustrative. The scope of the present disclosure should be determined by reasonable interpretation of the appended claims, and all changes within the equivalent scope of the present disclosure are included in the scope of the present disclosure. In addition, claims that do not have explicit citation relationships in the claims may be combined to form embodiments or may be included as new claims by amendments after filing.

### INDUSTRIAL APPLICABILITY

The embodiments of the present disclosure can be applied to various wireless access systems. Examples of various wireless access systems include 3rd Generation Partnership Project (3GPP) or 3GPP2 systems.

The embodiments of the present disclosure can be applied not only to the various wireless access systems described above, but also to all technical fields that apply the various wireless access systems. Furthermore, the proposed method can also be applied to mm Wave and THz communication systems that use ultra-high frequency bands.

Additionally, the embodiments of the present disclosure can also be applied to various applications such as autonomous vehicles and drones.

1. A method comprising:
determining whether a Signal Level Enhanced Network Selection (SENSE) is applicable; and
performing a Public Land Mobile Network (PLMN) selection based on whether the SENSE is applicable,
wherein, based on the SENSE being applicable to a User Equipment (UE), the PLMN selection is performed based on a signal threshold, and
wherein, based on the SENSE not being applicable to the UE, the PLMN selection is performed based on a priority, and
wherein whether the SENSE is applicable is determined based on whether the UE supports at least one access technology among access technologies related to a signal threshold configured in a Universal Subscriber Identity Module (USIM).

2. The method of claim 1, wherein the signal threshold configured in the USIM is an operator-controlled signal threshold per access technology.

3. The method of claim 2, wherein the operator-controlled signal threshold per access technology is indicated by an EF_{OCST} file in the USIM.

4. The method of claim 2, wherein the operator-controlled signal threshold per access technology includes at least one of a value of SENSE enabled by an operator indicating whether a SENSE function is enabled, a home operator-controlled signal threshold, or an access technology.

5. The method of claim 4, wherein whether the SENSE is applicable is further determined based on information of the SENSE enabled by the operator.

6. The method of claim 1, wherein determining whether the SENSE is applicable comprises:
determining that the SENSE is applicable based on the UE supporting the at least one access technology among the access technologies related to the signal threshold configured in the USIM; and
determining that the SENSE is not applicable based on the UE not supporting any of the access technologies related to the signal threshold configured in the USIM.

7. The method of claim 1, wherein whether the SENSE is applicable is further determined based on whether at least one of the following conditions is satisfied:
a first condition indicating that the UE is in automatic PLMN selection mode;
a second condition indicating that the UE supports an operator-controlled signal threshold per access technology;
a third condition indicating that the UE is configured to use the SENSE; and
a fourth condition indicating that the operator-controlled signal threshold per access technology is configured in the USIM.

8. The method of claim 1, wherein the UE is a stationary internet of things (IoT) UE.

9. (canceled)

10. A communication device-User Equipment (UE) comprising:
at least one processor; and
at least one computer memory connected to the at least one processor and storing instructions that, based on being executed by the at least one processor, perform operations comprising:
determining whether a Signal Level Enhanced Network Selection (SENSE) is applicable; and
performing a Public Land Mobile Network (PLMN) selection based on whether the SENSE is applicable,
wherein, based on the SENSE being applicable to the UE, the PLMN selection is performed based on a signal threshold,
wherein, based on the SENSE not being applicable to the UE, the PLMN selection is performed based on a priority, and
wherein whether the SENSE is applicable is determined based on whether the UE supports at least one access technology among access technologies related to a signal threshold configured in a Universal Subscriber Identity Module (USIM).

11. A non-transitory computer-readable medium storing at least one instruction,
executable by a processor,
to cause User Equipment (UE) to perform operations comprising:
determining whether a Signal Level Enhanced Network Selection (SENSE) is applicable; and
performing a Public Land Mobile Network (PLMN) selection based on whether the SENSE is applicable,
wherein, based on the SENSE being applicable to the UE, the PLMN selection is performed based on a signal threshold,
wherein, based on the SENSE not being applicable to the UE, the PLMN selection is performed based on a priority, and
wherein whether the SENSE is applicable is determined based on whether the UE supports at least one access technology among access technologies related to a signal threshold configured in a Universal Subscriber Identity Module (USIM).
